(19) United States
(12) Patent Application Publication
(10) Pub. No.: US 2013/0173612 A1
(43) Pub. Date: Jul. 4, 2013

(54) Social Net Advocacy for Providing Categorical Analysis of User Generated Content

(71) Applicant: DELL PRODUCTS L.P., Round Rock, TX (US)

(72) Inventors: Shesha Shah, Bangalore (IN); Rajiv Narang, Austin, TX (US); Munish Gupta, Austin, TX (US)

(73) Assignee: DELL PRODUCTS L.P., Round Rock, TX (US)

(21) Appl. No.: 13/683,551

(22) Filed: Nov. 21, 2012

Related U.S. Application Data
(63) Continuation-in-part of application No. 13/027,607, filed on Feb. 15, 2011.

(51) Int. Cl. G06F 17/30

(52) U.S. Cl. CPC G06F 17/3053
USPC 707/731

(57) ABSTRACT

A method and system are disclosed for providing categorical analysis of user interactions within a social media environment. Social media interactions are monitored, collected, and processed to generate social network advocacy (SNA) analyses, which are in turn processed to categorize associated SNA data into predetermined SNA categories. Analysis operations are then performed on the resulting categorized SNA data to generate an SNA value for each of the SNA categories, along with associated statistical analyses, which are then used to provide the basis for proactive marketing response responses within one or more social media environments.

### CONTINUING DATA

This application is a continuation-in-part of U.S. patent application Ser. No. 13/027,607, filed on Feb. 15, 2011, entitled “Social Net Advocacy Process and Architecture” by inventors Shesha Shah and Rajiv Narang, which describes exemplary methods and systems and is incorporated by reference in its entirety.

### CROSS REFERENCE TO RELATED APPLICATIONS

U.S. patent application Ser. No. 13/027,651, filed Feb. 15, 2011, entitled “Social Net Advocacy Business Applications” by inventors Shesha Shah and Rajiv Narang, describes exemplary methods and systems and is incorporated by reference in its entirety.

U.S. patent application Ser. No. 13/027,682, filed Feb. 15, 2011, entitled “Social Net Advocacy Measure” by inventors Shesha Shah and Rajiv Narang, describes exemplary methods and systems and is incorporated by reference in its entirety.

U.S. patent application Ser. No. 13/027,738, filed Feb. 15, 2011, entitled “Social Net Advocacy Contextual Text Analytics” by inventors Shesha Shah and Rajiv Narang, describes exemplary methods and systems and is incorporated by reference in its entirety.

### BACKGROUND OF THE INVENTION

1. Field of the Invention

Embodiments of the invention relate generally to information handling systems. More specifically, embodiments of the invention provide a method and system for a method and system is disclosed for providing categorical analysis of user interactions within a social media environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

These same information handling systems have been just as instrumental in the rapid adoption of social media into the mainstream of everyday life. Social media commonly refers to the use of web-based technologies for the creation and exchange of user-generated content for social interaction. As such, it currently accounts for approximately 22% of all time spent on the Internet. More recently, various aspects of social media have become an increasingly popular for enabling customer feedback, and by extension, they have likewise evolved into a viable marketing channel for vendors. This new marketing channel, sometimes referred to as “social marketing,” has proven to not only have a higher customer retention rate than traditional marketing channels, but to also provide higher demand generation “lift.”

Traditional methods of measuring the effectiveness of a social media channel include Social Media Analytics (SMA), determining a Net Promoter Score (NPS), and likewise determining a Brand Health Score (BHS). NPS is a customer loyalty metric intended to reduce the complexity of implementation and analysis frequently associated with measures of customer satisfaction with the objective of creating more “Promoters” and fewer “Detractors.” As such, a Net Promoter Score is intended to provide a stable measure of business performance that can be compared across business units and even across industries while increasing interpretability of changes in customer satisfaction trends over time. Currently, several approaches are known for defining, calculating and monitoring a Brand Health Score. In general, these approaches typically include the generation of a score card that comprises a mix of leading and lagging indicators of the health of a brand, whether individually, or as part of a brand portfolio.

Such scores assist executives in understanding the return on investment (ROI) of their marketing investments, and by extension, the value of long-term versus short-term investments. However, neither of these approaches provides social media channel feedback in real-time, nor do they provide actionable information at a granular level, such as by industry segment, product line, or a topic of discussion. As a result, marketers are unable to proactively react to changes in consumer sentiment in a categorical context, which can adversely affect revenue and profits.

### SUMMARY OF THE INVENTION

A method and system are disclosed for providing categorical analysis of user interactions within a social media environment. In various embodiments, a social network advocacy (SNA) system is implemented to monitor one or more social media environments for user interactions that are related to a target subject, such as vendor's product. In these and other embodiments, the social media interactions are monitored and collected by a social media crawler and then stored in a repository of SNA data.

In turn, the SNA system accesses the SNA data to generate measurements of user interactions within various social media environments and vendor sites, which are then processed to generate associated SNA reports along with various transactional measurements. In these various embodiments, an SNA analytics module likewise uses the SNA data to perform SNA analysis operations, which in combination with the SNA reports result in the generation of SNA analyses. In one embodiment, the SNA analyses comprise key performance indicators (KPIs). In various embodiments, the SNA analyses, and KPIs if included, are used to categorize the SNA data into predetermined SNA categories. Analysis operations are then performed on the resulting categorized SNA data to generate an SNA value for each SNA category. In various embodiments, a plurality of SNA category values is processed to generate an aggregate SNA value for the associated SNA categories.

In certain embodiments, a first set of SNA category values are processed with a second set of SNA category values to generate a set of SNA category variance values, which in turn respectively correspond to the plurality of SNA categories. In this and other embodiments, the first set of SNA category values are associated with a first time interval and the second set of SNA category values are associated with a second time interval. In these various embodiments, the SNA category variance values respectively correspond to the increase or decrease of each SNA category value over a period of time. In various embodiments, a first aggregate SNA value is processed with a second aggregate SNA value to generate an aggregate SNA variance value. The categorized SNA data and associated statistical analyses are then displayed within an SNA system user interface (UI) to provide the basis for proactive marketing responses within one or more social media environments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of the components of an information handling system as implemented in the system and method of the present invention;

FIG. 2 is a simplified block diagram showing an implementation of a social network advocacy (SNA) system;

FIG. 3 is a simplified block diagram showing a social media customer relationship management (CRM) analytical cycle;

FIG. 4 is a simplified block diagram showing the effect on social media feedback channels as a result of implementing an SNA system;

FIG. 5 is a simplified block diagram of the architecture of an SNA system;

FIG. 6 is a simplified block diagram showing the aggregation and processing of social network advocacy (SNA) data to generate social media conversation analysis data;

FIG. 7 is a generalized flow chart of the operation of an SNA system;

FIG. 8 is a generalized depiction of the effect of an implementation of an SNA system on market capitalization value;

FIG. 9 is a simplified block diagram showing the operation of an SNA system for providing categorical analysis of user interactions within a social media environment and generating proactive responses thereto;

FIG. 10 shows the display of a first level of SNA categorization and analysis data within a user interface; and

FIG. 11 show the display of a second level of SNA categorization and analysis data within a user interface.

### DETAILED DESCRIPTION

A method and system is disclosed for providing categorical analysis of user interactions within a social media environment. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

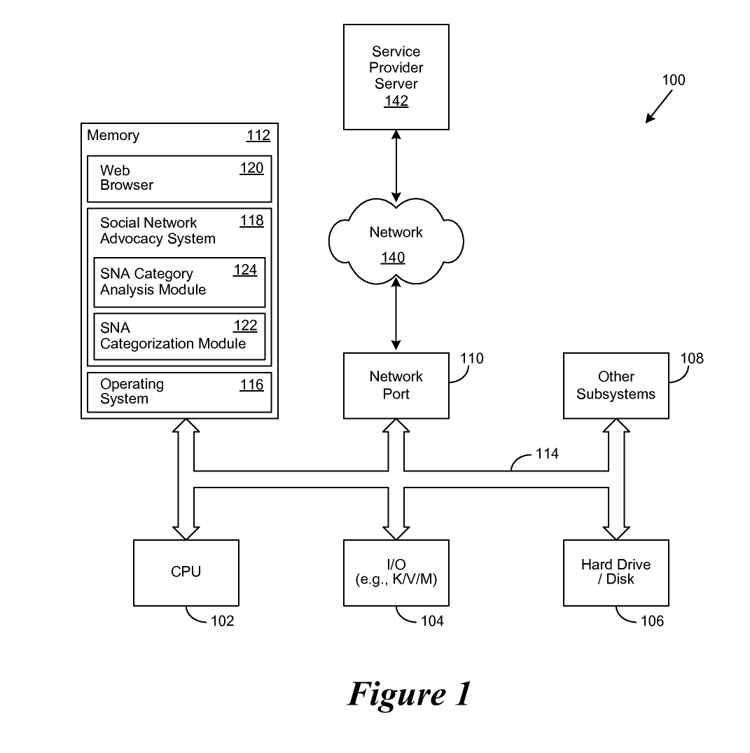

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and a Web browser 126. In various embodiments, the system memory 112 may also comprise a social network advocacy (SNA) system 118. In certain of these embodiments, the SNA system 118 comprises an SNA categorization module 122 and an SNA category analysis module 124. In one embodiment, the information handling system 100 is able to download the Web browser 126 and the social network advocacy system 118 from the service provider server 142. In another embodiment, the social network advocacy system is provided as a service from the service provider server 142.

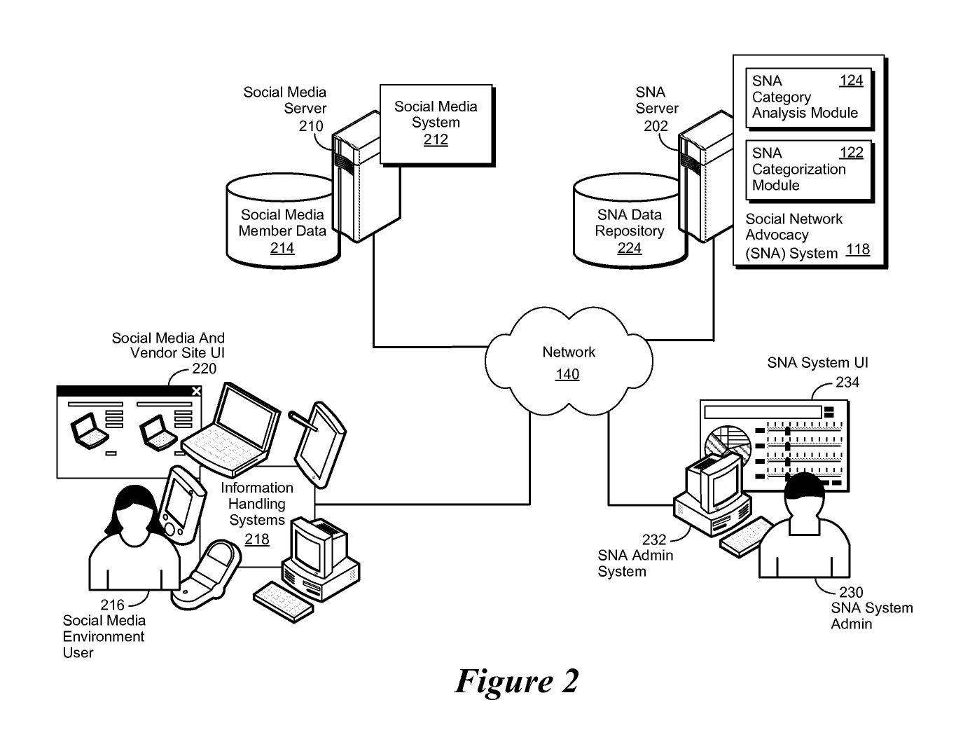

FIG. 2 is a simplified block diagram showing an implementation of a social network advocacy (SNA) system in accordance with an embodiment of the invention. As used herein, social net advocacy (SNA) refers to a metric that provides a measure of the effect on the health of a business as a result of user interactions conducted within a social media environment. More specifically, it measures the net influence resulting from the user interactions generated by ravers, who generate positive interactions, and ranters, who generate negative interactions, within one or more social media environment. As such, it provides a correlation to a vendor's, or a vendor's product's, Net Promoter Score (NPS) and Brand Health scores on a near-real-time basis and provides a single, actionable metric to track. By combining the monitoring of user interactions (e.g., a conversation, as described in greater detail herein) with customer profiling data, it likewise provides immediate measurement of the effects of marketing, support, and public relation actions viewed at the enterprise, business unit, market segment, product, sub-brand and geographical levels. As a result, the trending of key performance indicators (KPIs) are supported, which provides more than a simple “pulse measurement” for a given point of time in the market. More specifically, social media interaction data is collected, and then processed in various embodiments to measure the affect of various social media user interactions while providing a vendor actionable data by gaining insight to the source and location of the interactions.

In various embodiments, an algorithm is implemented with the SNA system to integrate the contextual influence of user behavior within a social media environment with transactional data, such as purchase of a vendor's product, to generate near-real-time feedback to pro-active marketing responses. As a result, the SNA system provides vendors answers to question such as what was the initial reaction to the product prior to general availability, and how did social media user interactions change after the product was released? It will be appreciated that other marketing-related questions can be answered, such as how the initial marketing efforts were received, especially for an online demand generator (ODG), and who were the primary promoters that drove positive social media conversations and responses. Likewise, the question of what were influencers saying about a product or one of its features can not only be answered, but also with a metric showing the quantifiable affect of their user interactions. Those of skill in the art will recognize that statistically significant changes in net advocacy represent opportunities for changes in pricing, brand health change, and other aspects related to the health of a business.

In various embodiments, an SNA system 118 is implemented to monitor user interactions and generate proactive marketing responses within a social media environment. In certain of these embodiments, the SNA system 118 comprises an SNA categorization module 122 and an SNA category analysis module 124. In these and other embodiments, a social media environment user 216 uses an information handling system 218 to log on to a social media environment, or site, enabled by a social media system 212, which is implemented on a social media server 210. As used herein, an information handling system 218 may comprise a personal computer, a laptop computer, or a tablet computer operable to exchange data between the social media environment user 216 and the social media server 210 over a connection to network 140. The information handling system 218 may also comprise a personal digital assistant (PDA), a mobile telephone, or any other suitable device operable to display a social media and vendor site user interface (UI) 220 and likewise operable to establish a connection with network 140. In various embodiments, the information handling system 218 is likewise operable to establish an on-line session over network 140 with the SNA system, which is implemented on an SNA server 202.

In this embodiment, SNA operations are performed by the SNA system 118 to monitor social media interactions related to a target subject, such as vendor's product. In one embodiment, the social media interactions are monitored and collected by a social media crawler operable to perform crawling operations in a target social media environment. The collected social media interactions are then stored in the SNA data repository 224. If it is determined that an increase in social media traffic related to the target subject is detected, then the social media traffic related to the target subject is processed to determine whether the subject traffic is positive or negative. If it is determined that the subject traffic is negative, then it is processed by the SNA system 118 to prioritize the most negative interactions. The source(s) (e.g., social media environment user 216) of the most negative interactions are identified and they are then displayed in an SNA system user interface (UI) 234 implemented on an SNA administrator system 232. Once displayed, the sources are reviewed by an SNA system administrator 230 to determine the issues causing the negative interactions. Once the issues have been determined, proactive actions are performed by the SNA system administrator 230, or a designated SNA system agent, to address the identified issue(s). Thereafter, the primary source(s) of the subject traffic is contacted by the SNA system administrator 230, or a designated SNA system agent, to gain a better understanding of the issues causing the negative interactions. Additional proactive actions are then performed by the by the SNA system administrator 230, or a designated SNA system agent, while tracking the results of the proactive actions and the relationship with the primary source(s) of the subject traffic.

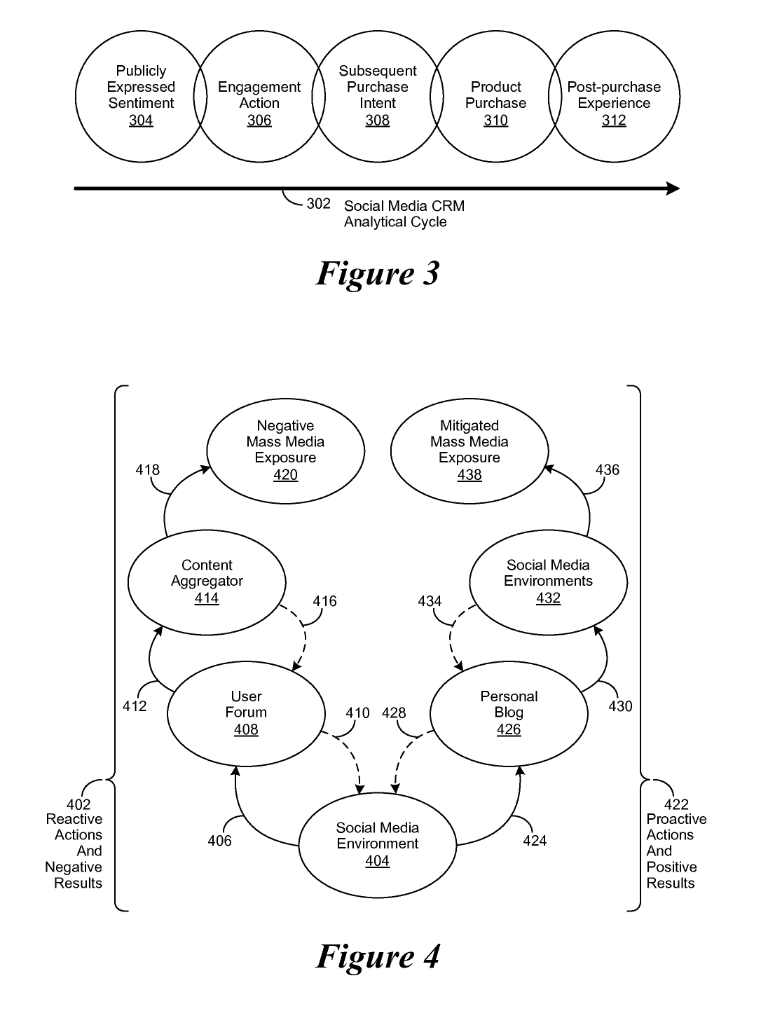

FIG. 3 is a simplified block diagram showing a social media customer relationship management (CRM) analytical cycle as implemented in accordance with an embodiment of the invention. In this embodiment, a social media CRM analytical cycle 302 comprises a publicly-expressed sentiment phase 304, an engagement action phase 306, a subsequent purchase intent 308 phase, a product purchase phase 310, and a post-purchase experience phase 312. As shown in FIG. 3, the associated action of a social media participant within each of the phases 306, 308, 310 and 312, from a CRM analysis standpoint, is dependent upon the effect of its predecessor phases.

As an example, a social media participant may read a highly-complimentary review of a product he or she may be considering purchasing during the publicly-expressed sentiment phase 304. As a result of that social media interaction, the social media participant may perform additional product research during the engagement action phase 306. Likewise, if additional product research is positive, such as user reviews of the product, then the social media participant may proceed to the vendor's web site in the subsequent purchase intent phase 308 to obtain additional information about the product. Assuming that the additional product information is appealing, and the social media participant has the means to execute a purchase, then he or she may purchase the product purchase phase 310. Likewise, once the product is received, and if the purchaser is happy with the product, then he or she may write a complimentary review for of the product during the post-purchase experience phase 312 for posting on a social media site.

From the foregoing, it will be apparent to those of skill in the art that a potential purchaser of a product may be either encouraged or dissuaded from purchasing the product based on pro or con sentiments about the product expressed by other members within a social media community. Accordingly, the ability to emphasize (e.g., “showcase”) positive comments, or mitigate the effects of negative comments, may have a direct and measurable effect on sales of a product.

FIG. 4 is a simplified block diagram showing the effect on social media feedback channels as a result of implementing a social networking advocacy (SNA) system in accordance with an embodiment of the invention. In this embodiment, one or more “conversations” are conducted between two or more users of a social media environment. As used herein, a “conversation” refers to an interaction within a social media environment between two or more users of the social media environment. As an example, a conversation may comprise a posting by an author of a blog, which in turn is read by one or more readers. As another example, a user may post a comment within a user forum, which in turn is read by one or more users, and in turn may or may not elicit a response from the one or more users. As yet another example, one user of a social media environment may ask a question of another user, which may or may not receive a response from the other user.

More specifically, a conversation is defined as a set of comments in a thread of user interactions within a social media environment. Each conversation has an author and a topic assigned to it, referenced to a predetermined ontology. In different embodiments, a conversation may originate from within a volume of user interactions, which in turn occur within one or more social media environments. Over time, the conversation may grow as additional users perform additional interactions, which are linked to the thread or related threads. In various embodiments, a conversation is defined as:

Conversation_j = { Author_j, Context_j, Thread_j, Relevance_j,

Date_j } _j

where:
Context_J = { (URL_j, Topic_j, Ontology_Node_j) }
Relevance_J = { (SearchEngine_rank_j, Campaign_j) }
Thread_j = { (Comment_ji, Author_ji)_ji }_i
Author_i = { UserID_i, CommunityID_i }
Comment_ji = { “Text”_ij, Date_ij }
CommunityID_i = { UserID_i, (DomainID_k, NetworkID_ik)_k }

where each networkID_ik has pairs of UserIDs and the weightage of the link is for the pair. It will be apparent to those of skill in the art that many such embodiments are possible and the foregoing is not intended to limit the spirit, scope, or intent of the invention.

In this embodiment, users of a social media environment 404 conduct conversations as described in greater detail herein. Without the implementation of an SNA system, reactive actions 402 are performed resulting in negative results, whereas with the implementation of an SNA system, proactive actions 422 are performed resulting in positive results. As an example, without the implementation of a SNA system, a user may post 406 a negative comment about a vendor's product in a user forum 408. In response, additional users may respond 410 with their own postings, either requesting additional details or perhaps adding negative comments of their own. Likewise, the negative comments may be collected 412 by a content collector 414 familiar to those of skill in the art. In turn, the collected negative comments, and their web address, may be referenced 416 by another posting by a user in the user forum 408. The collected negative comments may also be sourced 418 by various media agencies resulting in negative mass media exposure 420.

In contrast, with the implementation of an SNA system, a user may post 424 a negative comment about a vendor's product in a personal blog 426. In response, readers of the personal blog 426 may respond 428 with requests for additional details or perhaps adding negative comments of their own. However, since the personal blog 426 is monitored by an SNA system operated by the vendor, then such issues, questions, and negative comments are captured as they are posted and the vendor is notified so they can act proactively. As an example, a representative of the vendor may request additional information about the product issue with a promise to research a solution and provide it to the author of the personal blog. Likewise, the author of the personal blog may broadcast or otherwise provide 430 their posting, directly or indirectly, to one or more additional social media environments 432. In response, users of those additional social media environments 432 may respond 434 with their own questions, responses, or negative comments. However, since the additional social media environments 432 are likewise monitored by an SNA system operated by the vendor, the vendor can act proactively in a like manner as previously described. Through the monitoring and collection 436 of the negative responses, and the resulting proactive activities performed by the vendor, the possibility of negative mass media exposure is mitigated 438.

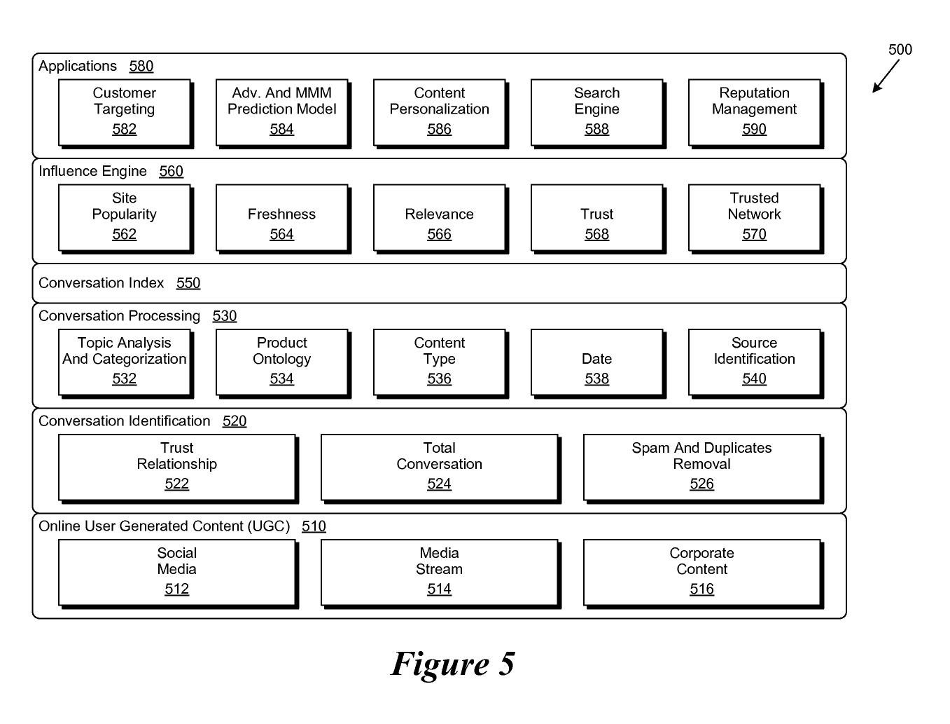

FIG. 5 is a simplified block diagram of the architecture of a social network advocacy (SNA) system as implemented in accordance with an embodiment of the invention. In this embodiment, the architecture of the SNA system 500 comprise online user-generated content 510, a conversation identification subsystem 520, a conversation processing subsystem 530, a conversation index 550, an influence engine 560, and applications 580. As shown in FIG. 5, the online user-generated content 510 comprises content that is generated by users of one or more social media 512 environments. The online user-generated content 510 likewise comprises content that is generated by media agencies and provided in a media stream 514, such as news feeds, and corporate content 516, such as content published by a vendor on their web site.

As likewise shown in FIG. 5, the conversation identification subsystem 520 comprises a trust relationship module 522, a total conversation module 524, and a spam and duplicates removal module 526. The spam and duplicates removal module 526 is used to remove spam and duplicate conversations or elements of conversations. The conversation processing subsystem 530 comprises a topic analysis and categorization module 532, a product ontology module 534, a content type module 536, a date module 532 to assign a date to a conversation, and a source identification module 540 for determining the source of a conversation. In one embodiment, the product ontology module 534 is implemented to manage the interrelationship of a vendor's products and their associated information. In another embodiment, the product ontology module 534 is implemented to manage the interrelationship of conversation topics and their corresponding categorizations, the content type and source of a conversation, and the date of the conversation as it relates to a vendor's product. In yet another embodiment, the product ontology module 534 is implemented manually. In still another embodiment, the product ontology module 534 is implemented automatically by the SNA system. In one embodiment the source identification module 540 identifies the author(s) of a conversation. In another embodiment, the source identification module 540 uses an “authority rating” as a factor to increase or decrease the relative influence rating of a conversation author. As an example, the managing editor of a trade publication may have a higher authority rating than a first-time poster to a technical help forum. As a result, the relative influence rating of the managing editor would be increased while the relative influence rating of the first-time poster would be decreased. The conversation index 550 is implemented in one embodiment to maintain an index of conversations and related information, such as the interrelationship information managed by the product ontology module 534.

As shown in FIG. 5, the influence engine subsystem 560 comprises a site popularity module 562 that determines the popularity of a social media environment or sub-environment, and a freshness module 564 that determines how recent a conversation took place. In one embodiment, the freshness module 564 determines the velocity, or how quickly, comments are added to a conversation by users of a social media environment. The influence engine subsystem 560 likewise comprises a relevance module 566 used to determine the relevance of a conversation to a vendor or their product(s) and a trust module 568 used to determine the trustworthiness of the source and content of the conversation. The influence engine subsystem 560 likewise comprises a trusted network module 570 used to capture conversations that occur on known and relevant sources.

The applications subsystem 580, as shown in FIG. 5, comprises a customer targeting module 582 used to target one or more customer and advertising and marketing mix modeling (MMM) prediction module 584. The applications subsystem 580 likewise comprises a content personalization module 586 for customizing content provided to a conversation, a search engine 588, and a reputation management module 590. In one embodiment, the reputation management module 590 is used to manage reputation data associated with a user of a social media environment. As used herein, reputation data refers to data associated with social commerce activities performed by a user of a social media environment and reflects customer loyalty.

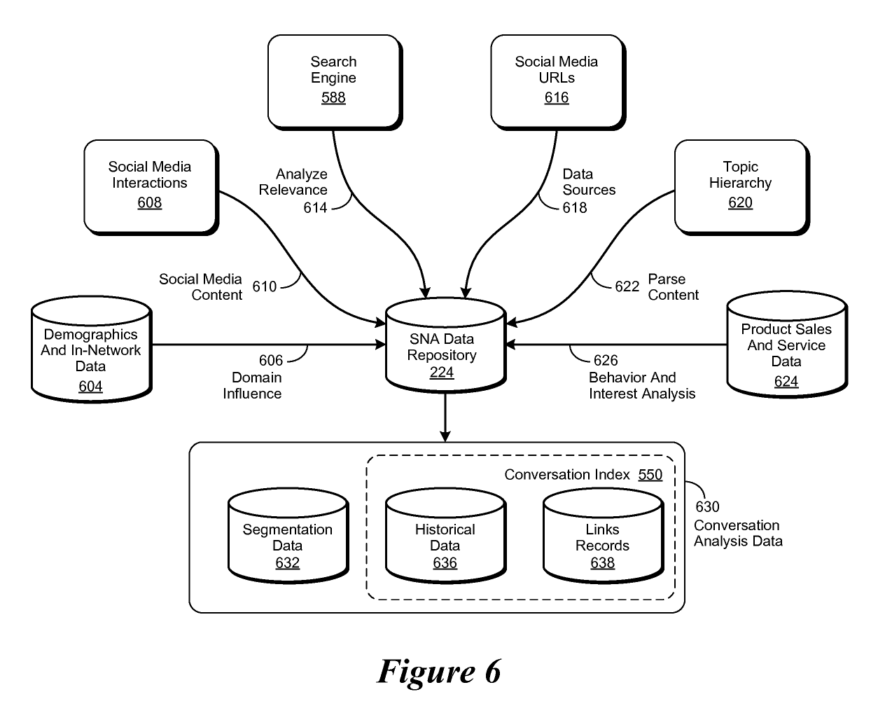

FIG. 6 is a simplified block diagram showing the aggregation and processing of social network advocacy (SNA) data in accordance with an embodiment of the invention to generate social media conversation analysis data. In this embodiment, an SNA data repository 224 comprises data provided by a demographics and in-network data repository 604, which is used to determine domain influence 606. As used herein, domain influence refers to relevance of a domain on topics and concepts related to conversation. The SNA data repository 224 likewise comprises data provided by a product sales and service data repository 624, which is used to perform behavior and interest analysis 626 of users of a social media environment. Likewise, the SNA data repository 224 receives data feeds resulting from social media interactions 608, which comprises social media content 610, and data feeds from a search engine 588, which are used for analyzing relevance 614 as it relates to SNA data. The SNA data repository 224 likewise receives social media Uniform Resource Locators (URLs) 616 as data feeds, which provide the location of the various data sources 618, and references a topic hierarchy 620, which is used to parse content 622.

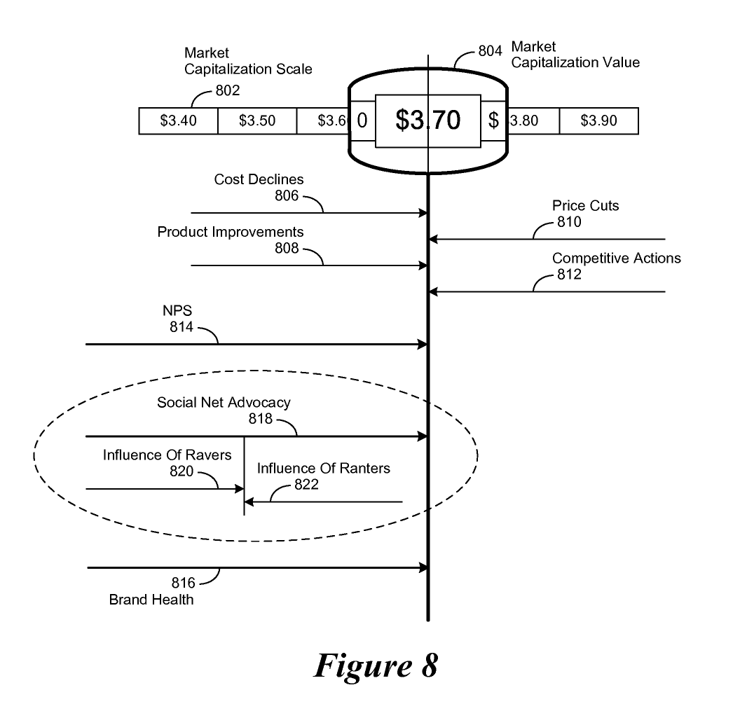

In this and other embodiments, data processing operations familiar to those of skill in the art are performed on data extracted from the SNA data repository 224 to generate conversation analysis data 630. As shown in FIG. 8, the conversation analysis data 630 comprises segmentation data 632 and a conversation index 550, which further comprises a repository of historical data 636 and a repository of links records 638. In one embodiment, the repository of segmentation data 632 is used to map users of a social media environment to a vendor's customers. In another embodiment, the repository of segmentation data 632 is used to further segment mapped users of a social media environment to various segments of a vendor's installed base or product lines. It will be apparent to skilled practitioners of the art that many such segmentation examples are possible and the foregoing is not intended to limit the spirit, scope or intent of the invention. In one embodiment, the repository of historical data 636 comprises historical conversations conducted in a social media environment, which are in turn cross-referenced to linking information, such as conversation thread identifiers, stored in the repository of links records 638.

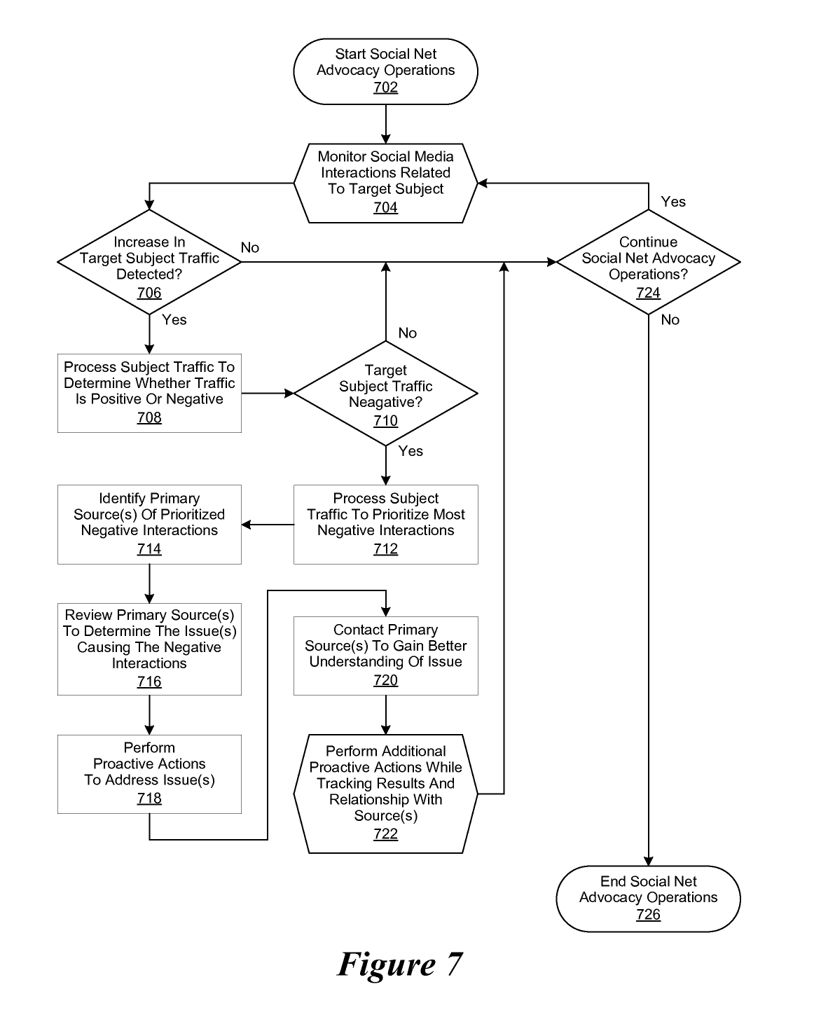

FIG. 7 is a generalized flow chart of the operation of a social network advocacy (SNA) system as implemented in accordance with an embodiment of the invention. In this embodiment, SNA operations are begun in step 702, followed by the monitoring of social media interactions related to a target subject in step 704. In one embodiment, the social media interactions are monitored and collected by a social media crawler operable to perform crawling operations in a target social media environment. A determination is then made in step 706 whether an increase in social media traffic related to the target subject is detected. If not, then a determination is made in step 724 whether to continue SNA operations. If so, then the process is continued, proceeding with step 704. Otherwise, SNA operations are ended in step 726.

However, if it is determined in step 706 that an increase in social media traffic related to the target subject is detected, then the social media traffic related to the target subject is processed to determine whether the subject traffic is positive or negative. A determination is then made in step 710 whether the subject traffic is negative. If not, then the process is continued, proceeding with step 724. Otherwise, the subject traffic is processed in step 712 to prioritize the most negative interactions. The source(s) of the most negative interactions are then identified in step 714 and they are then reviewed in step 716 to determine the issues causing the negative interactions. Once the issues have been determined, proactive actions are performed in step 718 to address the identified issue(s). Thereafter, the primary source(s) of the subject traffic is contacted in 720 to gain a better understanding of the issues causing the negative interactions. Additional proactive actions are then performed in step 722 while tracking the results of the proactive actions and the relationship with the primary source(s) of the subject traffic. The process is then continued, proceeding with a making a determination in step 724 whether to continue SNA operations. If so, then the process is continued, proceeding with step 704. Otherwise, SNA operations are ended in step 726.

FIG. 8 is a generalized depiction of the effect of an implementation of a social network advocacy (SNA) system on market capitalization value in accordance with an embodiment of the invention. As shown in FIG. 8, a market capitalization scale 802 comprising a plurality of per-share stock values further comprises a current market capitalization value 804 based on a current per-share stock price. It will be appreciated that the current market capitalization value 804 may be positively influenced by cost declines 806 or product improvements 808, such as new features, or negatively influenced by price cuts 810 or reactive competitive actions 812. It will likewise be appreciated that the changes in the current market capitalization value 804 may be correlated to changes in a vendor's, or a vendor's product's, Net Promoter Score (NPS) 814 and its Brand Health Score (BHS) 816. However, these correlations typically happen after the fact and are results-based. In contrast, the positive affect of social net advocacy 818 is realized from proactive efforts resulting from the implementation of a SNA system as described in greater detail herein. As shown in FIG. 8, the positive affect of social net advocacy 818 is increased by facilitating the influence of ravers 820 while mitigating the influence of ranters 822.

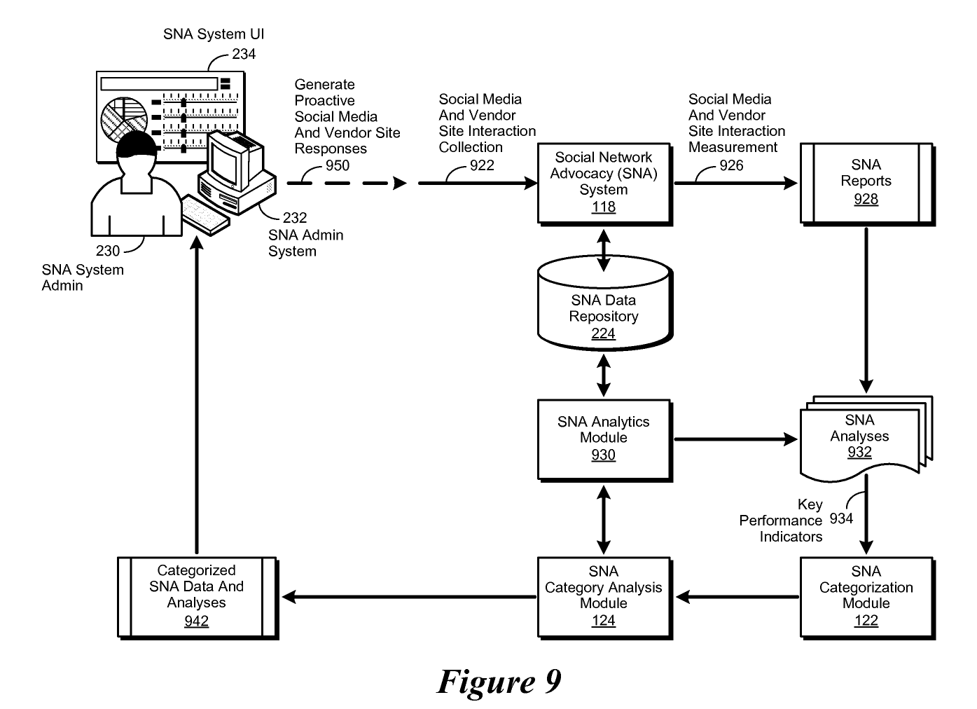

FIG. 9 is a simplified block diagram showing the operation of a social network advocacy (SNA) system as implemented in accordance with an embodiment of the invention for providing categorical analysis of user interactions within a social media environment and generating proactive responses thereto. In this embodiment, various user interactions within one or more social media environments and vendor sites, as described in greater detail herein, are collected and provided 922 to an SNA system 118.

In turn the SNA system 118 accesses SNA data stored in the SNA data repository 224, which is then used to perform SNA operations likewise described in greater detail herein. The SNA operations result in the generation of measurements of user interactions within various social media environments and vendor sites, which are then processed 926 to generate associated SNA reports 928. In this and other embodiments, an SNA analytics module 930 likewise accesses SNA data stored in the SNA data repository 224, which is then used to perform SNA analysis operations. In various embodiments, natural language processing (NLP) approaches familiar to skilled practitioners of the are used to perform the analysis operations. These analysis operations, in combination with SNA reports 928, result in the generation of SNA analyses 932. In one embodiment, the SNA analyses 932 comprise key performance indicators (KPIs) 934. In turn, the SNA analyses 932, and KPIs 934 if included, are used by a SNA topic categorization module 122 to categorize the SNA data into predetermined SNA categories.

As used herein, an SNA category broadly refers to a class, or grouping, of user interactions within a social media environment that share certain properties or characteristics. As such, an SNA category may variously refer to a geography (e.g., “Southwest region”), a market segment (e.g., “consumer”), a group (e.g., a company's field service technicians), an industry (e.g., “), an object (e.g., a product), a customer, a business function (e.g., customer service), a topic of discussion (e.g., product features and benefits), and so forth. An SNA category may also be a member of a set of SNA categories. As an example, SNA categories “Owning and Using,” “Service,” “Choose a Product,” and “Waiting and Delivery” may all be peer members of an SNA “Customer Journey” group category. Likewise, an SNA category may comprise a set of SNA category subsets. As an example, an SNA “Service” category may comprise “Resolving Query,” “Post Purchase,” “Service Rep,” “Hardware,” “WinX Operating System,” “Rep,” “Guides and Instructions,” and “Software-Service” SNA category subsets. To further the example, the SNA category subsets may be topics related to the SNA “Service” category. Skilled practitioners of the art will recognize that many such examples are possible and the foregoing is not intended to limit the spirit, scope or intent of the invention.

Analysis operations are then performed on the resulting categorized SNA data by an SNA topic statistical analysis module 124. In various embodiments, the statistical analysis operations are performed by the SNA topic statistical analysis module 124 interacting with the SNA analytics module 930. In these and other embodiments, an SNA value is generated for each SNA category. In one embodiment, a plurality of SNA category values is processed to generate an aggregate SNA value for the associated SNA categories. In another embodiment, the aggregate SNA value is a simple average of the plurality of SNA category values. In yet another embodiment, the aggregate SNA value is a weighted average of the plurality of SNA category values. In still another embodiment, statistical operations familiar to those of skill in the art are used to generate the aggregate SNA value from the plurality of SNA category values.

In various embodiments, a first set of SNA category values are processed with a second set of SNA category values to generate a set of SNA category variance values, which in turn respectively correspond to the plurality of SNA categories. In this and other embodiments, the first set of SNA category values are associated with a first time interval and the second set of SNA category values are associated with a second time interval. In these various embodiments, the SNA category variance values respectively correspond to the increase or decrease of each SNA category value over a period of time. In various embodiments, a first aggregate SNA value is processed with a second aggregate SNA value to generate an aggregate SNA variance value.

The SNA topic statistical analysis module 124 then provides the categorized SNA data and associated statistical analyses 942 for display within an SNA system user interface (UI) 234 implemented on an SNA administrator system 232. In various embodiments, the categorized SNA data comprises the first set of SNA category values, the second set of SNA category values, the first aggregate SNA category value, the second aggregate SNA category value, the set of SNA category variance values, and the aggregate SNA category variance value. The categorized SNA data and statistical analyses displayed within the SNA system UI 234 are then used by the SNA system administrator 230 to generate 950 proactive marketing responses within one or more social media environments and the vendor's web site.

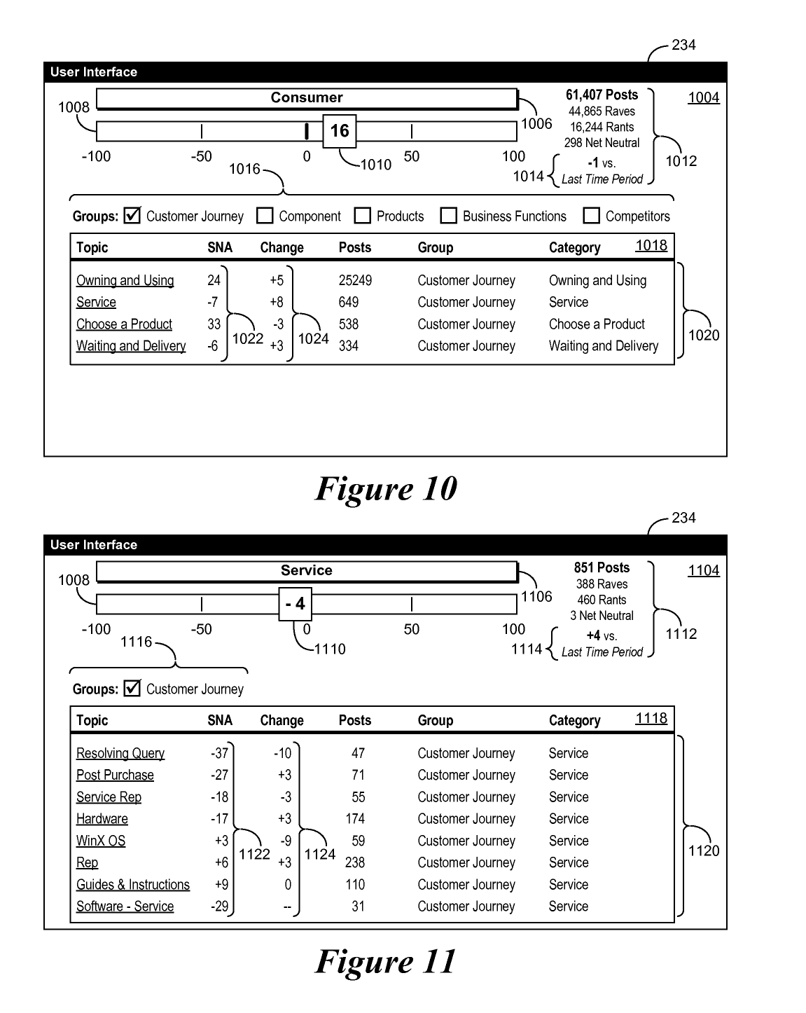

FIG. 10 shows the display of a first level of social network advocacy (SNA) categorization and analysis data as implemented within a user interface in accordance with an embodiment of the invention. In this embodiment, an SNA user interface (UI) 234 comprises an SNA “Consumer” 1006 category summary window 1004, which in turn comprises an SNA category value scale 1008, an SNA category statistics list 1012, a plurality of SNA category selection boxes 1016, and an SNA sub-category value summary window 1018. As shown in FIG. 10, the “Consumer” 1006 SNA category has a current aggregate SNA category value 1010 of ‘16’ and a current aggregate SNA category variance value 1014 of ‘−1’. As likewise shown in FIG. 10, the “Customer Journey” category has been selected from the plurality of SNA category selection boxes 1016. As a result, the SNA sub-category value summary window 1018 displays a plurality of SNA topic categories 1020, each of which has a corresponding SNA category value 1022 and an SNA category variance value 1024, as described in greater detail herein.

FIG. 11 show the display of a second level of social network advocacy (SNA) categorization and analysis data as implemented within a user interface in accordance with an embodiment of the invention. In this embodiment, an SNA user interface (UI) 234 comprises an SNA “Service” 1106 category detail window 1104, which in turn comprises an SNA category value scale 1008, an SNA sub-category statistics list 1112, a “Customer Journey” selection box 1116 that has been selected from the SNA sub-category value summary window 1018 shown in FIG. 10, and an SNA sub-sub-category value summary window 1018. As shown in FIG. 11, the “Service” 1006 SNA sub-category has a current aggregate SNA category value 1110 of ‘−4’ and a current aggregate SNA category variance value 1114 of ‘+4’. As likewise shown in FIG. 11, the SNA sub-sub-category value summary window 1118 displays a plurality of SNA topic categories 1120, each of which has a corresponding SNA category value 1122 and an SNA category variance value 1124, as described in greater detail herein.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also, for example, while FIGS. 9-11 are directed towards describing analysis of SNA categories and associated topics, other processes and user interfaces which are directed towards describing analysis of SNA media providers, authors and associated posts are also contemplated.

Consequently, the invention is intended to be limited only by the spirit and scope of the appended claims, giving full cognizance to equivalents in all respects.

What is claimed is:

1. A computer-implementable method for providing categorical analysis of user interactions within a social media environment, comprising:
receiving a first set of social network advocacy (SNA) data associated with a first conversation conducted within a social media environment;
processing the first set of SNA data to generate a first set of SNA analysis data;
processing the first set of SNA data and the first set of SNA analysis data to generate a set of first SNA data subsets;
performing a first set of association operations to associate individual first SNA data subsets with individual SNA categories of a set of SNA categories; and
processing the individual first SNA data subsets associated with each individual SNA category to generate a first set of SNA category values respectively corresponding to the individual SNA categories.

2. The method of claim 1, wherein:
a second set of SNA data is received, the second set of SNA data associated with a second conversation conducted within a social media environment;
the second set of SNA data is processed to generate a second set of SNA analysis data;
the second set of SNA data is processed with the second set of SNA analysis data to generate a set of second SNA data subsets;
a second set of association operations is performed to associate individual second SNA data subsets with individual categories of the set of SNA categories; and
the individual second SNA data subsets associated with each individual SNA category are processed to generate a second set of SNA category values respectively corresponding to the individual SNA categories.

3. The method of claim 2, wherein:
the first set of SNA category values is associated with a first time interval, and
the second set of SNA category values is associated with a second time interval.

4. The method of claim 3, wherein:
the first set of SNA category values is processed to generate a first aggregate SNA category value; and
the second set of SNA category values is processed to generate a second aggregate SNA category value.

5. The method of claim 4, wherein:
the first and second sets of SNA category values are processed to generate a corresponding set of SNA category variance values; and
the first and second Aggregate SNA category values are processed to generate an aggregate SNA category variance value.

6. The method of claim 5, wherein SNA category data is provided within a window of a user interface, the SNA category data comprising at least one of the set of:
the first set of SNA category values;
the second set of SNA category values;
the first aggregate SNA category value;
the second aggregate SNA category value;
the set of SNA category variance values; and
the aggregate SNA category variance value.

7. A system comprising:
a processor;
a data bus coupled to the processor; and
a computer-usable medium embodying computer program code, the computer-usable medium being coupled to the data bus, the computer program code interacting with a plurality of computer operations and comprising instructions executable by the processor and configured for:
receiving a first set of social network advocacy (SNA) data associated with a first conversation conducted within a social media environment;
processing the first set of SNA data to generate a first set of SNA analysis data;
processing the first set of SNA data and the first set of SNA analysis data to generate a set of first SNA data subsets;
performing a first set of association operations to associate individual first SNA data subsets with individual SNA categories of a set of SNA categories; and
processing the individual first SNA data subsets associated with each individual SNA category to generate a first set of SNA category values respectively corresponding to the individual SNA categories.

8. The system of claim 7, wherein:
a second set of SNA data is received, the second set of SNA data associated with a second conversation conducted within a social media environment;
the second set of SNA data is processed to generate a second set of SNA analysis data;
the second set of SNA data is processed with the second set of SNA analysis data to generate a set of second SNA data subsets;
a second set of association operations is performed to associate individual second SNA data subsets with individual categories of the set of SNA categories; and
the individual second SNA data subsets associated with each individual SNA category are processed to generate a second set of SNA category values respectively corresponding to the individual SNA categories.

9. The system of claim 8, wherein:
the first set of SNA category values is associated with a first time interval, and
the second set of SNA category values is associated with a second time interval.

10. The system of claim 9, wherein:
the first set of SNA category values is processed to generate a first aggregate SNA category value; and
the second set of SNA category values is processed to generate a second aggregate SNA category value.

11. The system of claim 10, wherein:
the first and second sets of SNA category values are processed to generate a corresponding set of SNA category variance values; and
the first and second Aggregate SNA category values are processed to generate an aggregate SNA category variance value.

12. The system of claim 11, wherein SNA category data is provided within a window of a user interface, the SNA category data comprising at least one of the set of:
the first set of SNA category values;
the second set of SNA category values;
the first aggregate SNA category value;
the second aggregate SNA category value;
the set of SNA category variance values; and
the aggregate SNA category variance value.

13. A non-transitory, computer-readable medium embodying computer program code, the computer program code comprising computer executable instructions configured for:
receiving a first set of social network advocacy (SNA) data associated with a first conversation conducted within a social media environment;
processing the first set of SNA data to generate a first set of SNA analysis data;
processing the first set of SNA data and the first set of SNA analysis data to generate a set of first SNA data subsets;
performing a first set of association operations to associate individual first SNA data subsets with individual SNA categories of a set of SNA categories; and
processing the individual first SNA data subsets associated with each individual SNA category to generate a first set of SNA category values respectively corresponding to the individual SNA categories.

14. The non-transitory, computer-readable medium of claim 13, wherein:
a second set of SNA data is received, the second set of SNA data associated with a second conversation conducted within a social media environment;
the second set of SNA data is processed to generate a second set of SNA analysis data;
the second set of SNA data is processed with the second set of SNA analysis data to generate a set of second SNA data subsets;
a second set of association operations is performed to associate individual second SNA data subsets with individual categories of the set of SNA categories; and
the individual second SNA data subsets associated with each individual SNA category are processed to generate a second set of SNA category values respectively corresponding to the individual SNA categories.

15. The non-transitory, computer-readable medium of claim 14, wherein:
the first set of SNA category values is associated with a first time interval, and
the second set of SNA category values is associated with a second time interval.

16. The non-transitory, computer-readable medium of claim 15, wherein:
the first set of SNA category values is processed to generate a first aggregate SNA category value; and
the second set of SNA category values is processed to generate a second aggregate SNA category value.

17. The non-transitory, computer-readable medium of claim 16:
the first and second sets of SNA category values are processed to generate a corresponding set of SNA category variance values; and
the first and second Aggregate SNA category values are processed to generate an aggregate SNA category variance value.

18. The non-transitory, computer-readable medium of claim 17, wherein SNA category data is provided within a window of a user interface, the SNA category data comprising at least one of the set of:
the first set of SNA category values;
the second set of SNA category values;
the first aggregate SNA category value;
the second aggregate SNA category value;
the set of SNA category variance values; and
the aggregate SNA category variance value.

19. The non-transitory, computer-readable medium of claim 13, wherein the computer executable instructions are deployable to a client computer from a server at a remote location.

20. The non-transitory, computer-readable medium of claim 13, wherein the computer executable instructions are provided by a service provider to a user on an on-demand basis.
